(19) United States
(12) Patent Application Publication
(10) Pub. No.: US 2020/0310077 A1
(43) Pub. Date: Oct. 1, 2020

(54) Driving Device, Camera Device and Electronic Apparatus

(71) Applicant: New Shicoh Motor Co., LTD, Zhejiang (CN)

(72) Inventors: LU ZHAO, Zhejiang (CN); Juhe ZHOU, Zhejiang (CN)

(21) Appl. No.: 16/826,716

(22) Filed: Mar. 23, 2020

(30) Foreign Application Priority Data
Mar. 28, 2019 (CN) 201910213608.5

(51) Int. Cl. G02B 7/02; H04N 5/225

(52) U.S. Cl. CPC G02B 7/026; H04N 5/2257; H04N 5/2254

(57) ABSTRACT

In an embodiment, a driving device includes a housing and a base. The housing includes an outer peripheral side wall and a top wall connected to the front side of the outer peripheral side wall, the top wall is provided with an opening allowing light to pass through, and the base supports the housing on the rear side of the housing. The inner peripheral surface of the outer peripheral side wall of the housing is provided with engaging grooves. The base is provided with side walls protruding from a front side surface on the front side thereof in correspondence with the engaging grooves of the outer peripheral side wall of the housing. The side walls are provided with engaging members. The engaging members are fitted into the engaging grooves.

### CROSS-REFERENCE TO RELATED APPLICATION

This application claims the benefit of Chinese patent application CN 201910213608.5 filed on Mar. 28, 2019, the contents of which are incorporated by reference herein.

### TECHNICAL FIELD

The present disclosure relates to a driving device, a camera device and an electronic apparatus.

### BACKGROUND

In the camera device of an electronic apparatus, the driving device drives the lens to move in the camera device through the interaction between the magnetic field generated when energizing the coil thereof and the magnetic field generated by the magnet, so as to achieve the purpose of focusing.

However, in the existing driving device on the market, the area of the connecting surface between the housing and the base is small, and the connection strength may be not enough.

### SUMMARY

An object of the present disclosure is to provide a driving device in which the connection strength between the housing and the base is high, and to provide a camera device and an electronic apparatus.

In accordance with a first aspect of the present disclosure, there is provided a driving device including a housing and a base. The housing includes an outer peripheral side wall and a top wall connected to the front side of the outer peripheral side wall, the top wall is provided with an opening allowing light to pass through, and the base supports the housing on the rear side of the housing The inner peripheral surface of the outer peripheral side wall of the housing is provided with engaging grooves. The base is provided with side walls protruding from a front side surface on the front side thereof in correspondence with the engaging grooves of the outer peripheral side wall of the housing. The side walls are provided with engaging members. The engaging members are fitted into the engaging grooves.

In accordance with a second aspect of the present disclosure, there is provided a camera device including the driving device as described above.

In accordance with a third aspect of the present disclosure, there is provided an electronic apparatus including the camera device as described above.

### DESCRIPTION OF THE DRAWINGS

The above and other features, properties and advantages of the present disclosure will become more apparent from the following description in conjunction with the accompanying drawings and Examples.

FIG. 1 shows an exploded schematic view of a driving device according to an embodiment;

FIG. 2 is a schematic perspective view of a base in the driving device;

FIG. 3 is a schematic perspective view of a housing in the driving device;

FIG. 4 is a schematic cross-sectional view of the driving device;

FIG. 5 is a schematic perspective view of the driving device in an assembled state; and

FIG. 6 is a front view of a smartphone mounted with a camera device including a driving device according to an embodiment of the present disclosure.

### DETAILED DESCRIPTION

The following description discloses various embodiments or Examples for implementing the subject technical solutions. The specific examples of the components and the arrangements are described below for the purpose of simplifying the disclosure, and of course, these are merely examples, and are not intended to limit the protection scope of the present application. For example, the specification may include an embodiment in which a first feature is formed over or on the second feature, and may include an embodiment in which the first and second features are formed by direct contact, and may also include an embodiment in which an additional feature is formed between the first feature and the second feature, so that the first feature and the second feature may not be directly related. Additionally, reference numerals and/or letters may be repeated in different examples in these disclosures. This repetition is for the sake of brevity and clarity, and does not by itself represent the relationship between the various embodiments and/or structures to be discussed. Further, when the first element is described to be connected or in combination with the second element, the description includes embodiments in which the first and second elements are directly connected or combined with each other, and also includes the use of one or more other intervening elements to indirectly connect or join the first and second elements to each other.

It should be noted that in the case of use, the “up”, “down”, “left”, “right”, “front”, “rear”, “top”, “bottom”, “positive”, “reverse”, “clockwise” and “counterclockwise” in the following description are only used for convenience and do not imply any specific fixed direction. In fact, they are used to reflect the relative position and/or direction between various portions of the object.

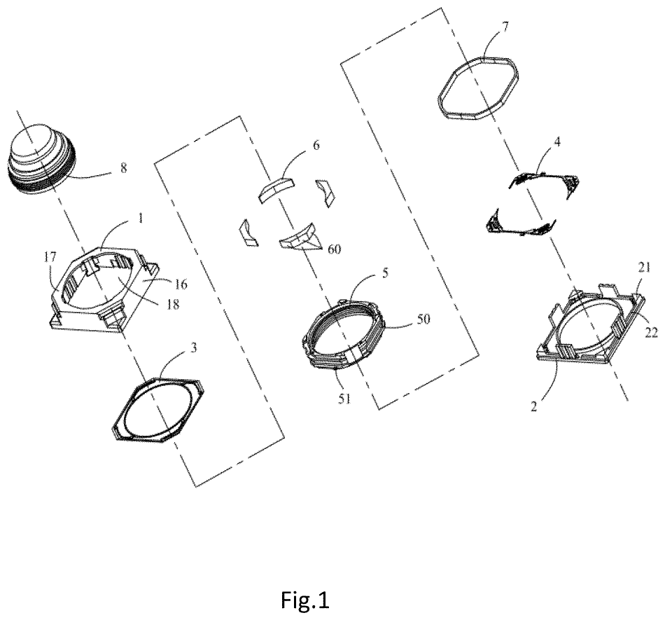

The driving device of the present embodiment is disposed in the camera device and is used for driving the lens to move along the optical axis, thereby playing a role of focusing. FIG. 1 shows an exploded schematic view of a driving device according to an embodiment. The driving device includes a housing 1 and a base 2 provided on the rear side of the housing 1 for supporting the housing 1. A front side spring 3, a rear side spring 4, a lens support 5, a magnet 6 and a coil 7 are respectively disposed in the housing 1. The dashed line shown in FIG. 1 indicates the optical axis of the lens 8 and passes through the center of the lens 8 and corresponds to the axis of the driving device and the axis of the housing 1. In the present embodiment, the object side in the optical axis direction of the lens 8 is set as the front side, and the opposite side is set as the rear side.

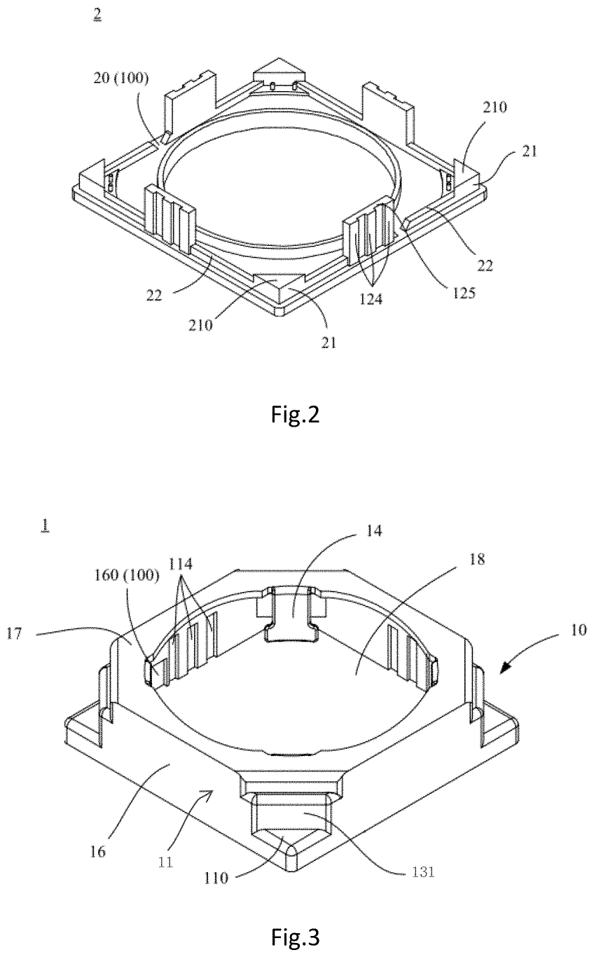

FIG. 2 is a schematic perspective view of a base 2 in the driving device. FIG. 3 is a schematic perspective view of the housing 1 in the driving device. The housing 1 has a square shape when viewed from the axial direction and includes an outer peripheral side wall 16 and a top wall 17 connected to the front side of the outer peripheral side wall 16. The top wall 17 is provided with an opening 18 that allows light to pass through in the camera device. Locking grooves 114 are formed on the inner side of the outer peripheral side wall 16 at the center portion of each side of the square of the housing 1. The locking grooves 114 are provided by three on each side, and all extend from the rear end to the front side in the axial direction.

The base 2 has a square shape when viewed from the axial direction, and the square shape of the housing 1 corresponds to the square shape of the base 2. Side walls 125 protruded forward are respectively provided on the front side surface of the base 2 at positions corresponding to the locking grooves 114. Locking members 124 are provided so as to protrude on the surface facing the outside of the side walls 125 corresponding to the shape of the locking grooves 114. That is, the locking members 124 are provided by three on each side and all extend from the front end of the side wall 125 toward the rear side in the axial direction. In addition, the base 2 has a surrounding structure 22 provided substantially all around the periphery thereof.

In the process of assembling the driving device, the housing 1 is combined to the base 2 from the front side. At this time, since the locking grooves 114 and the locking members 124 extend in the same axial direction, the housing 1 can be smoothly combined with the base 2. Usually, the inner side surface of the outer peripheral side wall 16 and the surrounding structure 22 are adhered and fixed, and the locking grooves 114 and the locking members 124 are further adhered and fixed. In the assembled state of the driving device, the locking members 124 are locked in the locking grooves 114, thereby further improving the firmness of the assembled housing 1 and the base 2.

Thus, in the assembled state, the locking members 124 are locked in the locking grooves 114, so that the housing 1 and the base 2 are fixed by the locking of the locking members 124 and the locking grooves 114, thereby improving the firmness between the housing 1 and the base 2 during fixing.

Although one Example of the present embodiment is as described above, in other Examples of the present embodiment, the housing 1 of the driving device may have more details in many aspects compared with the above-mentioned Example, and at least a part of these details may have various variations. At least a part of these details and variations will be described below with some Examples.

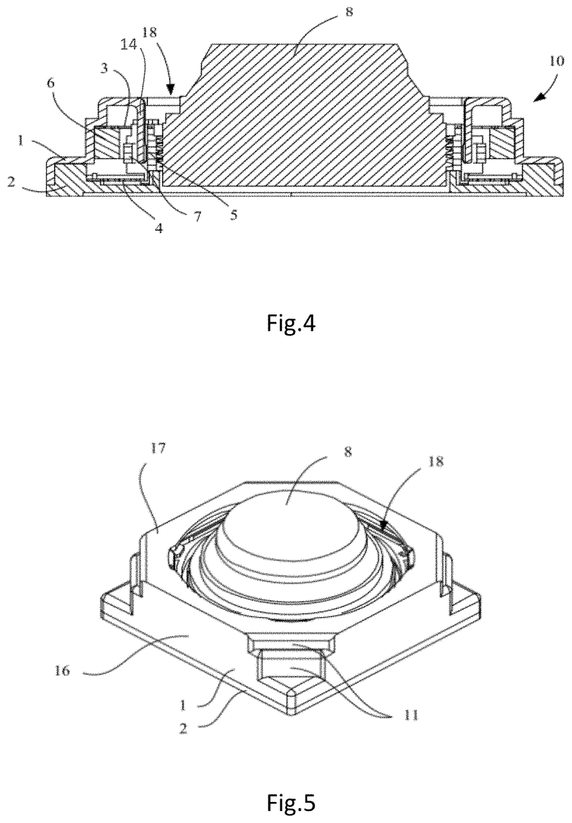

FIG. 4 is a schematic cross-sectional view of the driving device. Referring to FIG. 4, other components of the driving device are described below. The lens support 5 is disposed within the housing 1 for supporting the lens 8. The front side spring 3 is disposed between the lens support 5 and the housing 1, and the rear side spring 4 is disposed between the lens support 5 and the base 2. The front side spring 3 and the rear side spring 4 elastically hold the lens support 5 in the housing 1, while allowing the lens support 5 to move in the optical axis direction (that is, the axial direction of the housing 1) when subjected to an driving force. In an embodiment different from that shown in the drawing, even when the front side spring 3 and the rear side spring 4 are disposed on at least one of the front side and the rear side of the lens support 5, they can also play a role of elastically supporting the lens support 5.

The coil 7 is provided by being wound with the axial direction of the housing 1 as a winding axis so as to surround the outer peripheral side of the lens support 5 and generates a magnetic circuit on the outer circumferential surface of the lens support 5 after being energized. The magnet 6 is disposed on the inner peripheral side of the housing 1. As shown in FIG. 3 and FIG. 4, the magnet 6 is absorbed to adhere to the housing 1 through the side surface 60 of the magnet 6 and is opposed to the coil 7 at a predetermined distance. When the coil 7 is energized with a current, the coil 7 generates an Ampere force by the action of an external magnetic field generated by the magnet 6 and drives the lens support and the lens to move in the optical axis direction (that is, the axial direction of the housing 1). It is to be noted that four coils 7 having a winding axis in a direction orthogonal to the optical axis may be fixed to the outer periphery of the lens support 5 and face the magnet 6.

FIG. 5 is a schematic perspective view of the driving device in an assembled state. As shown in FIG. 1, a coil winding post 51 is provided on the outer peripheral side of the lens support 5. The coil winding post 51 extends in a radial direction of the lens support 5 for wiring the coil 7 inside the driving device. As shown in FIG. 2, on the front side surface of the base 2, there is a surrounding structure 22 protruding and extending forward and provided around the base 2. The surrounding structure 22 may be a convex rib provided around the base 2. The surrounding structure 22 has a broken section to from an avoidance notch 20 on the base 2. Correspondingly, an avoidance opening 160 is provided on the housing 1 at a position corresponding to the avoidance notch 20. When the housing 1 is assembled with the base 2, the avoidance opening 160 and the avoidance notch 20 are connected and communicated with each other to form an avoidance path 100 on the housing 1. With reference to FIGS. 1 to 5, it can be seen that in the assembled state, the housing 1 and the base 2 are connected with each other and the lens support 5 is accommodated in the housing 1. At this time, the avoidance path 100 provides an accommodation space for the coil winding post 51 of the lens support 5 in the housing 1. Since in the assembled state, the coil winding post 51 in the lens support 5 is directly accommodated in the avoidance path 100 of the housing 1, there is no need to reserve a space for placing the coil winding post 51 inside the housing, thereby reducing the size of the housing.

In the present embodiment, the rear side end surface of the outer peripheral side wall 16 of the housing 1 is preferably adhered to a front side surface adjacent to the outer peripheral surface of the surrounding structure 22 on the base 2, thereby further improving the firmness of the adhesion between the housing 1 and the base 2.

In the present embodiment, when assembling, it is preferable that an adhesive may also be applied on the contact surfaces of the locking members 124 and the locking grooves 114, so as to adhere the locking members 124 and the locking grooves 114 to further enhance the assembly firmness.

In the present embodiment, it is preferable that the side wall 125 is a part of the surrounding structure 22 of the base 2, so that the base 2 can form the surrounding structure 22 and the side wall 125 by integral molding.

As shown in FIG. 3, in the present embodiment, the housing 1 is made of a permeability magnetic material, and the magnet 6 is adsorbed to be stuck to the inner peripheral side of the housing 1. The housing 1 further includes an inner peripheral side wall 14. The inner peripheral side wall 14 is provided so as to extend from an edge portion of an opening 18 provided on the inner peripheral side of the top wall 17 toward the rear side, and correspond to each second step vertical wall 131 so as to face each other in a direction orthogonal to the axial direction of the housing 1. Specifically, the inner peripheral side wall 14 is provided on the outer side of the axis of the housing 1 corresponding to each magnet 6 during assembling, and the magnetic field of the magnet 6 makes the region where the inner peripheral side wall 14 is located an effective magnetic field region. As can be seen from FIG. 4, the coil 7 is disposed between the magnet 6 and the inner peripheral side wall 14, and a magnetic circuit is formed between the inner peripheral side wall 14 and the side of the magnet 6 opposite the coil. When the coil 7 is energized with a current, the magnetic can generate an Ampere force to the energized coil, thereby pushing the coil 7 to move.

In the present embodiment, the housing 1 has a rectangular shape, and the magnets 6 are provided at the four corner portions 10 of the housing 1, so that the size of the housing can be reduced while ensuring the internal space of the housing 1. In some other embodiments different from that shown in the figure, the housing 1 may also have other suitable polygonal shapes.

In the present embodiment, each of the corner portions 10 of the housing 1 includes a step portion 11 recessed downward in the thickness direction of the housing 1 and formed in a stepped shape. The step portion 11 includes a step horizontal surface 110 extending in a direction intersecting with the axial direction of the housing 1. Correspondingly, the base 2 is provided with protruding tables 21 protruding from four corners of the base 2 toward the front side thereof. In the assembled state, the housing 1 is abutted to the base 2. At this time, the table surface 210 of the protruding table 21 is adhered to the rear side surface of the step horizontal surface 110 (that is, the surface opposite to the table surface), thereby further improving the firmness of the connection of the housing 1 and the base 2.

In the present embodiment, the protruding tables 21 are a part of the surrounding structure 22 of the base 2, so that the base 2 can be manufactured by integral molding.

Further, as shown in FIG. 1, in the present embodiment, the lens support 5 is provided with a coil engaging groove 50 in the middle of the outer peripheral side thereof, and the coil 7 is fixed on the lens support 5 by being wound to be provided in the coil engaging groove 50. The coil winding post 51 is provided behind the coil engaging groove 50 to correspond to the position of the avoidance path 100 of the housing 1.

In one embodiment of the driving device, the driving device is disposed in the camera device and the lens 8 is the lens of the camera device.

In an embodiment of the camera device, the aforementioned camera device is disposed in an electronic device such as a notebook computer or a mobile phone.

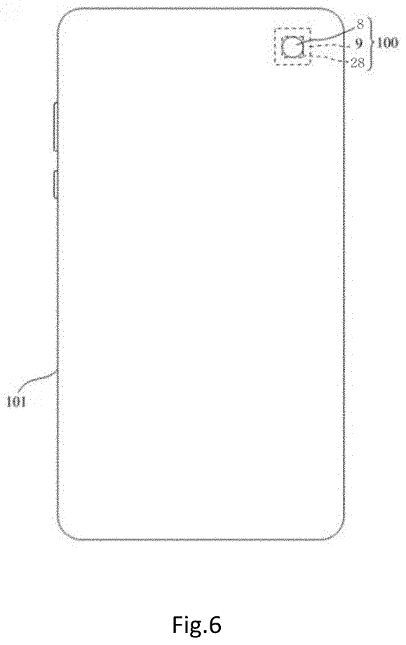

FIG. 6 shows an embodiment of an electronic apparatus including the camera device described above. The camera device 100 shown in FIG. 7 includes the driving device 9 according to an embodiment of the present disclosure, and is embedded in the case body of the smartphone 101 according to an embodiment of the present disclosure. The camera device 100 includes a lens support 5; an image sensor 28 converting light incident through the lens 8 supported by the lens support 5 into an image signal; and a driving device 9 constituted as described above.

The present disclosure is disclosed in the above preferred embodiments, but is not intended to limit the present disclosure, and any changes and modifications may be made by those skilled in the art without departing from the spirit and scope of the present disclosure. Therefore, any alternations, equivalent changes, and modifications made to the above examples in accordance with the technical essence of the present disclosure without departing from the technical solution of the present disclosure shall fall within the scope of protection defined by the claims of the present disclosure.

What is claimed is:

1. A driving device comprising:
a housing comprising an outer peripheral side wall and a top wall connected to a front side of the outer peripheral side wall, the top wall being provided with an opening allowing light to pass through; and
a base supporting the housing on a rear side of the housing; wherein,
an inner peripheral surface of the outer peripheral side wall of the housing is provided with locking grooves,
wherein the base is provided with side walls protruding from a front side surface on the front side thereof in correspondence with the locking grooves of the outer peripheral side wall of the housing, the side walls being provided with locking members, and
the engaging members are locked in the engaging grooves.

2. The driving device according to claim 1, further comprising:
a magnet disposed on the outer peripheral side wall;
a lens support disposed in the housing;
a spring supporting the lens support on at least one of a front side and a rear side of the lens support; and
a coil disposed on an outer peripheral side of the lens support.

3. The driving device according to claim 2, wherein,
the lens support is provided with a coil winding post,
the base comprises a surrounding structure provided substantially all around the periphery of the base on the front side surface of the base,
the surrounding structure is formed with an avoidance notch,
the inner peripheral surface of the outer peripheral side wall is formed with an avoidance opening at a position corresponding to the avoidance notch,
an outer peripheral surface of the surrounding structure is adhered to an inner peripheral surface of a rear side of the outer peripheral side wall,
the avoidance notch is communicated with the avoidance opening to form an avoidance path, and
the avoidance path accommodates the coil winding post.

4. The driving device according to claim 3, wherein a rear side end surface of the outer peripheral side wall is further adhered to the front side surface of the base adjacent to the outer peripheral surface of the surrounding structure.

5. The driving device according to claim 3, wherein the side wall is a part of the surrounding structure.

6. The driving device according to claim 1, wherein the front side surface of the base is provided with protruding tables corresponding to each of corner portions of the housing,
the outer peripheral side wall of the housing is provided with step horizontal surfaces corresponding to the protruding tables, and
the step horizontal surfaces are adhered to the protruding tables.

7. The driving device according to claim 3, wherein the front side surface of the base is provided with protruding tables corresponding to each of corner portions of the housing,
the outer peripheral side wall of the housing is provided with step horizontal surfaces corresponding to the protruding tables,
the step horizontal surfaces are adhered to the protruding tables, and
the protruding tables are a part of the surrounding structure.

8. A camera device comprising the driving device according to claim 1.

9. An electronic apparatus comprising the camera device according to claim 8.
